(19) United States
(12) Patent Application Publication
(10) Pub. No.: US 2015/0142852 A1
(43) Pub. Date: May 21, 2015

(54) DECLARATIVE AUTHORIZATIONS FOR SQL DATA MANIPULATION

(71) Applicants: Anett Lippert, Speyer (DE); Wolfgang Orlich, Sanhausen (DE); Ralf Miko, Wallduern (DE); Matthias Buehl, Heidelberg (DE)

(72) Inventors: Anett Lippert, Speyer (DE); Wolfgang Orlich, Sanhausen (DE); Ralf Miko, Wallduern (DE); Matthias Buehl, Heidelberg (DE)

(21) Appl. No.: 14/081,604

(22) Filed: Nov. 15, 2013

(51) Int. Cl. G06F 21/62

(52) U.S. Cl. CPC G06F 21/6218
USPC 707/785

(57) ABSTRACT

The present disclosure describes methods, systems, and computer program products for providing declarative authorizations for SQL data manipulation. One computer-implemented method includes defining a data access model by: defining at least one aspect to be used as an authorization-relevant attribute for a resource entity, defining a path definition from the resource entity to the at least one aspect to relate the at least one aspect to the resource entity the authorization is restricted on, defining at least one restriction for the at least one aspect as part of the path definition, wherein defining the at least one restriction includes determining which constraint condition are to be used and how the constraint conditions are to be combined, and defining/assigning a role to a user, the role defining authorization to the resource entity using, at least in part, the at least one aspect, and deploying a data control language document.

### BACKGROUND

Data accessed from a database is typically restricted to authorized individuals/organizations. For example, an individual may be allowed to access data related to members of an employment department or sales data based on the individual's relation to a customer and/or sales organization. Data restrictions are normally determined by an application used to access the data in the database, for example by an application developer implementing authorization checks. Erroneous and/or incomplete implementation of authorization checks can result in data access denial, data security breaches, and/or inefficiency in a database and/or systems accessing data from the database.

### SUMMARY

The present disclosure relates to computer-implemented methods, computer-readable media, and computer systems for providing declarative authorizations for SQL data manipulation. One computer-implemented method includes defining a data access model by: defining at least one aspect to be used as an authorization-relevant attribute for a resource entity, defining a path definition from the resource entity to the at least one aspect to relate the at least one aspect to the resource entity the authorization is restricted on, defining at least one restriction for the at least one aspect as part of the path definition, wherein defining the at least one restriction includes determining which constraint condition are to be used and how the constraint conditions are to be combined, and defining/assigning a role to a user, the role defining authorization to the resource entity using, at least in part, the at least one aspect, and deploying a data control language document.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising making an existing path from the at least one aspect to a user a part of the at least one aspect so that it can be evaluated when a role is assigned to the user.

A second aspect, combinable with any of the previous aspects, wherein the path definition can be defined by additional links that do not directly come from the entity-relationship model.

A third aspect, combinable with any of the previous aspects, wherein defining the at least one restriction further comprises linking the defined path to the resource entity to the at least one aspect with a logical quantifier.

A fourth aspect, combinable with any of the previous aspects, wherein defining a restriction further comprises: selecting one or more restrictions and combining them with logical operators, and deciding which type of access the defined restriction grants to the resource entity.

A fifth aspect, combinable with any of the previous aspects, further comprising dynamically generating at least one core data service authorization view based on the deployed DCL document.

A sixth aspect, combinable with any of the previous aspects, further comprising enhancing received query commands using the core data service authorization view.

The subject matter described in this specification can be implemented in particular implementations so as to realize one or more of the following advantages. First, a need to implement special authorization checks into the application coding is eliminated. In other words, an application developer does not have to consider/implement data access applications/objects to protect data. Second, the entity-relation (ER) data model becomes part of an overall authorization model and data authorizations are read from the authorization model on-the-fly by the database to determine whether a requestor has access to requested data. If access is not allowed, the accessing user/application is notified. Third, overall system performance increases as data is not read from the database, transferred, for example to an application server, and access authorization determined at the application server. Here, the data is requested and transferred only if authorized to be accessed. The authorization checks are pushed away from data-requesting applications to authorization views developed from the authorization model. Fourth, data authorization data is centralized, making it more secure, consistent, and robust. The use of authorization views makes the authorization process easy to declare and understand. The assignment of data control language (DCL) authorizations to users is easier than the assignment of database privileges to users and results in a lower total cost of ownership (TCO). Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1A illustrates an example of a standard database authorization mechanism according to an implementation.

FIG. 1B illustrates a different example of a standard database authorization mechanism according to an implementation.

FIG. 2 illustrates a model with a complete path from a user to an entity according to an implementation.

FIG. 3 illustrates example data control language (DCL) syntax for core data services (CDS) according to an implementation.

FIG. 4 illustrates an enhanced model using constraints according to an implementation.

FIG. 5 illustrates an example of a role definition and assignment of the role definition to a user according to an implementation.

FIG. 6 illustrates an example of a generated CDS view and select statement enhanced by the addition of the CDS view according to an implementation.

FIG. 7 illustrates example runtime generated views according to an implementation.

FIG. 8 is a high-level block diagram of an example distributed computing system (EDCS) for providing declarative authorizations for SQL data manipulation according to an implementation.

FIG. 9 is a block diagram of an exemplary computer used in the EDCS according to an implementation.

FIG. 10 is a flow chart illustrating a method for providing declarative authorizations for SQL data manipulation according to an implementation.

Like reference numbers and designations in the various drawings indicate like elements.

### DETAILED DESCRIPTION

This disclosure generally describes computer-implemented methods, computer-program products, and systems for providing declarative authorizations for SQL data manipulation. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Data accessed from a database is typically restricted to authorized individuals/organizations. For example, an individual may be allowed to access data related to members of an employment department or sales data based on the individual's relation to a customer and/or sales organization. Data restrictions are normally determined by an application used to access the data in the database, for example by an application developer implementing authorization checks. Erroneous and/or incomplete implementation of authorization checks can result in data access denial, data security breaches, and/or inefficiency in a database and/or systems accessing data from the database.

The following disclosure describes a declarative authorization model (DAM) modeling authorization paths for database resources using entity relationships/associations described in an entity-relation (ER) data model as authorization paths. A modified structured query language (SQL)—data control language (DCL)—is used to describe authorizations. An authorization decision of whether a subject is authorized to access a certain resource instance and subset of the instance is also based on whether relationships exist between resource instances. Given a particular ER data model, it is possible to derive suitable authorization artifacts automatically (e.g., true if, as described below, “artifacts”=authorization value proposals). In the case of an incomplete ER data model, the DAM closes the missing connections between the subject and the resource.

Using the DAM, authorization views can be automatically generated and persisted as SQL views. When an authorization view is assigned to a user, user specific instance restrictions are specified. The user specific restriction values are persisted at the user authorization assignment. An advantage is that the number of authorization views doesn't increase with the number of different restriction values.

An application developer is not troubled with authorizations when implementing SQL manipulation statements. At runtime, matching authorization views are combined automatically by the infrastructure to a user-executed SQL statement. An authorization view “matches” if it is assigned to the user and if it is related to the resource. If no matching authorization view could be found, the SQL statement is not authorized for the user and will not be executed. In some implementations, if a SQL statement is not authorized, a requesting user can be notified, for example using a user interface (UI), message, etc.

A typical authorization concept allows using predefined roles that gives functional access to certain data resources. When roles are assigned to a user it is possible to restrict this role to give the user access only to the resources (entity instances) the user is required to work with. This instance restriction is possible following the organizational structure that is used by the company in general. For example, the company might be organized by departments (e.g., organizational units), by country, and/or by some other criteria. The user administrator can restrict entity access following one or more of these criteria. The system supports the administrator by proposing authorization values for a user following his organizational classification.

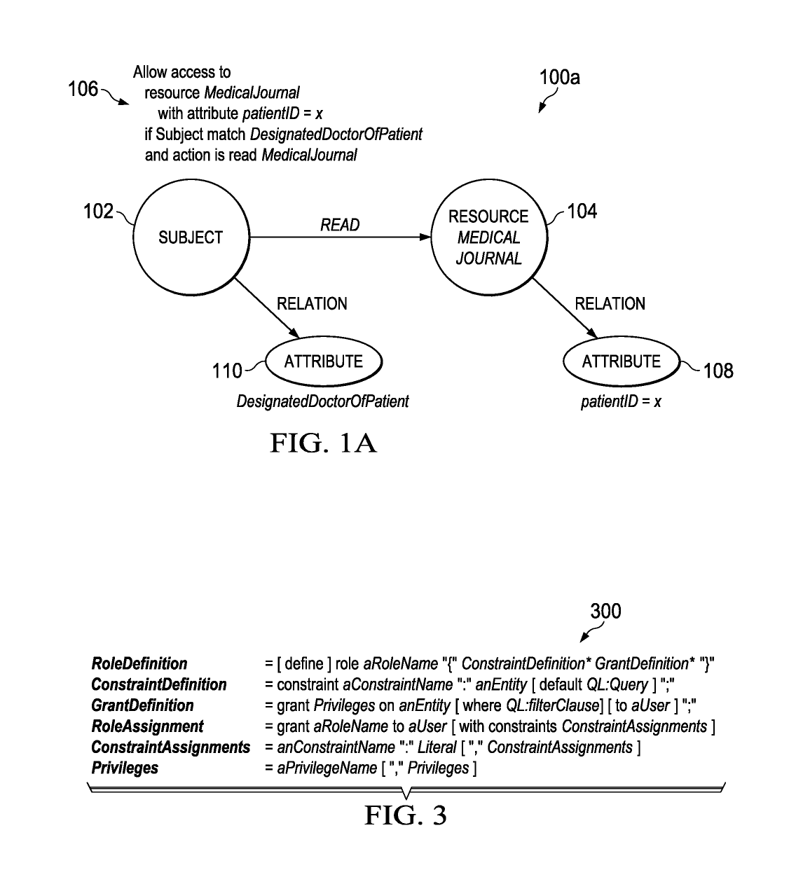

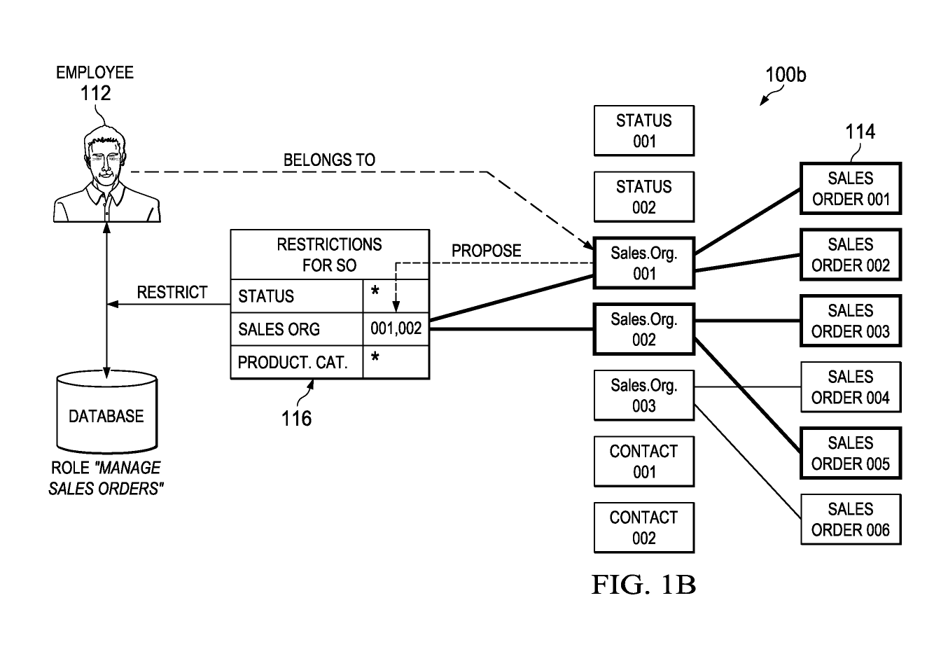

FIG. 1A illustrates an example 100a of a standard database authorization mechanism according to an implementation. A subject user 102 wishes to access (e.g., read) a resource (e.g., MedicalJournal 104). The illustrated pseudocode 106 shows that the subject user 102 is authorized to read the resource MedicalJournal 104 data with a relation to attribute patientID 108 (here equal to some value of “x” for a particular patient) only if the subject user 102 matches a DesignatedDoctorOfPatient 110 relation to a patient with attribute patientID 108 equal to “x.” Here the access check for the data is hardcoded and checked once the resource MedicalJournal 104 is retrieved from a database or other persistency.

FIG. 1B illustrates a different example 100b of a standard database authorization mechanism according to an implementation. Here, the employee 112 is part of sales organization 001 and the administrator proposes to give the employee 112 with an assigned role of “ManageSalesOrders” access to all sales orders (SO) belonging to sales organization 001. Access to sales orders 114 are restricted by the restrictions 116 (here by sales organization). For example, users that are members of sales organizations “001” can access sales orders 001 and 002. Likewise, users that are members of sales organization “002” can access sales orders 003 and 005. Note that a request by an individual user would be formatted similarly as that illustrated in FIG. 1.

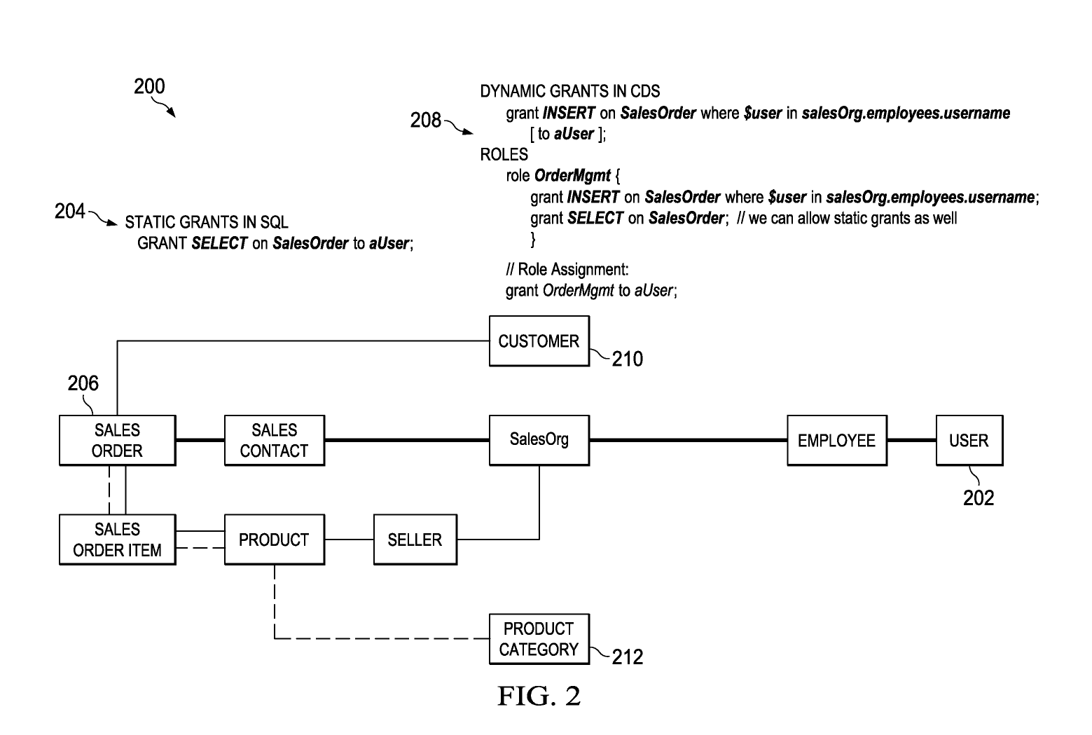

FIG. 2 illustrates an entity-relationship (ER) model 200 with a complete path from a user to an entity according to an implementation. Here the ER model 200 has a complete path defined by the ER data model 200 from the user 202 to other resources of the ER data model 200. Here, a DAM has been previously modeled and provides the authorizations to users. The DAM is contained in a data control language (DCL) document described below. Within the DAM exists a declarative description of the authorizations. In some implementations, the DAM is identical to the associations of the ER data model 200 (e.g., database tables connected by one or more database keys). Using the pre-defined DAM, an administrator can grant access to a user, for example user 202, using either a simple functional SQL statement or an instance-based enhanced SQL standard in a core data service (CDS). For example, standard SQL 204 grants select authority on the SalesOrder resource 206 to a specified user “aUser” (a user 202). However, using CDS enhanced SQL statements 208, an administrator can grant authority (here INSERT) on the SalesOrder resource 206 with further constraints. In the example, the constraints include where a user name ($user) is in a particular username database table (salesOrg.employees.username) with an optional “to aUser” value. In some implementations, a role (OrderMgmt) can also be defined as illustrated. To assign the defined role to a particular user, a modified grant statement can be used as illustrated (“grant OrderMgmt to aUser”). The enhanced SQL (or data control language (DCL) syntax) adds flexibility and functionality to permit authorization definitions to be defined in a SQL-like syntax, simplifying authorization declarations.

FIG. 3 illustrates example DCL syntax 300 for CDS according to an implementation. The illustrated DCL statements are for example only and, as will be appreciated by those of ordinary skill in the art, can be modified in many possible ways to provide functionality consistent with this disclosure. Other such syntax, commands, parameters, and/or structures are also considered to be within the scope of this disclosure.

Returning to FIG. 2, some drawbacks from the illustrated example include an inability to authorize other values, for example, the administrator might want to authorize additional values that are not directly derived from the ER model 200—such as a sales person is authorized for their “own” sales organization and also for another sales organization where they are helping in a temporary capacity. Also, a complete path from the Customer 210 and Product Category 212 resources may not exist—for example, a path is missing in cases where there is not a relation between a user and a constraint. In the illustrated ER model 200, a user is not directly related to a “product category” but does have a relation to a “Sales Organization” by their position as an employee in the company. Other drawbacks include difficulty in demonstrating to an administrator what has been authorized in the illustrated ER model 200 and that auditability functionality is missing and/or lacking.

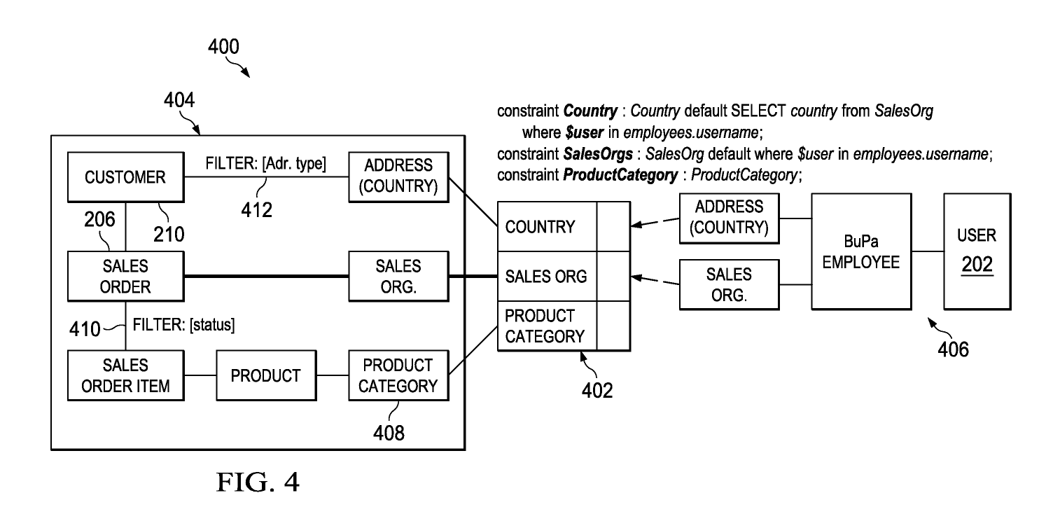

FIG. 4 illustrates an enhanced model 400 using constraints according to an implementation. In order to address drawbacks associated with the model illustrated in FIG. 2, constraints are introduced into the model, for example, constraints 402 (table and sample code defining each constraint). The constraints 402 form a “connector” between ER models, here a business model 404 (typically developed by an application developer) and a user model 406. Example constraints are illustrated above the table of constraints 402. Among other things, the constraints 402 allow restrictions to be placed on resource entities without a complete modeled path, provide predefined building blocks for an administrator for resource entity instance restrictions, and provide the possibility of authorizing other values.

Having authorization to access a certain resource entity instance means on a technical level that there exists a connection (path) between the user and the resource entity to be accessed. The path can be defined by the ER data model or by additional links that do not directly come from the model (e.g., the above-described constraints 402). With constraints 402, authorization modeling defines all access paths between a user and an entity instance. The system can propose existing paths and complete partial paths from the ER data model. In addition, a role modeler can define which instance restriction is relevant for a particular use case (e.g., which path is evaluated on a technical level). In typical instances, the role modeler is more of a developer who is tasked with building the roles that correspond to the different business tasks in an organization. Role modeling is part of application development and can be part of customizing in a customer's organization. A user administrator can decide per user which conditions need to be fulfilled so that a user can access the instances authorized for as well as assigning roles and restrictions to users.

As an example, in FIG. 4, if the user administrator wants to give access to sales orders restricted by Sales Organization, the user administrator would enter the Sales Organizations that they want to authorize in the table in the line “Sales Org.” In some implementations, the system can support a user (or other) administrator by dynamically proposing the sales organization(s) the user belongs to (e.g., in a user interface). In some implementations, the business model is invisible to a user (or other administrator) and access to entity instances is provided through the constraints 402.

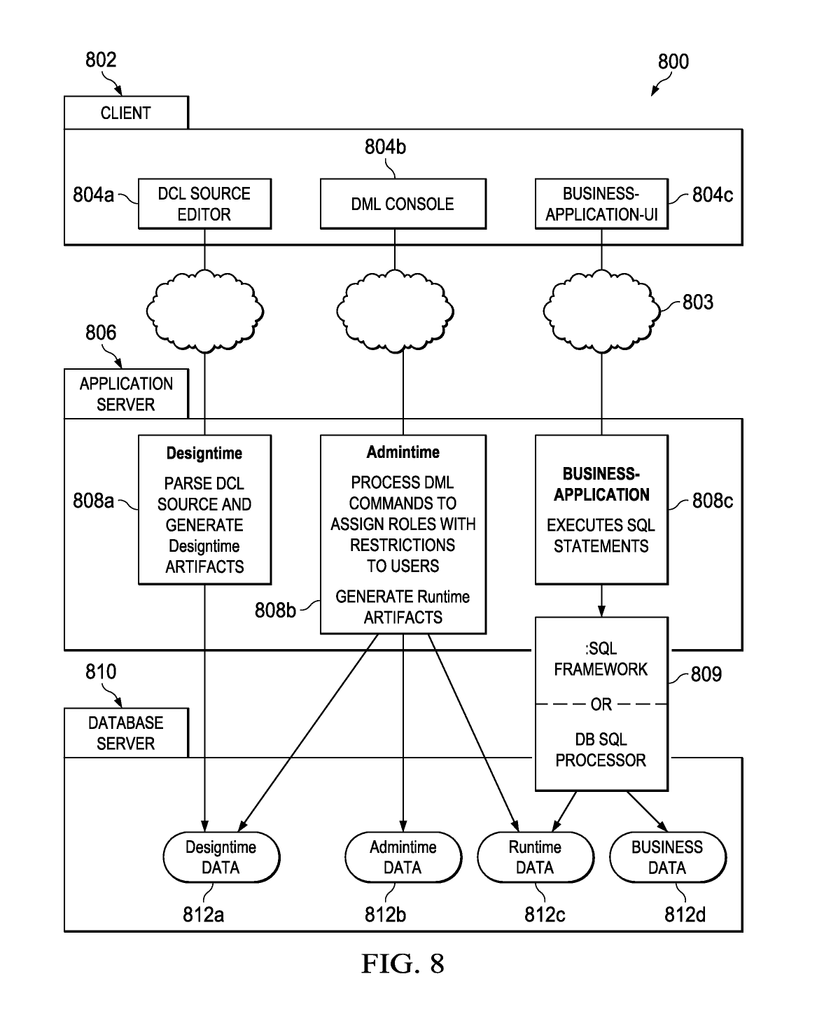

The following description describes the creation of the DAM. The creation of the DAM typically takes place during a design time period by an authorization developer using a tool, such as DCL source editor interfacing with a design time application on an application server. Design time data is then generated and pushed a database server (refer to FIG. 8 for additional detail). As will be appreciated by those of ordinary skill, the described steps are for example only and can be rearranged, combined, and modified without departing from the scope of this disclosure.

First, the authorization developer defines aspects (constraints) to be used as authorization relevant attributes for a certain resource entity. In the example of FIG. 4 for the resource entity “Sales Order,” the aspects “Country” (of the customer), the “Sales Org” of the Sales Order and the “Product Category” of the Products sold within the sales order are used. In some implementations, commonly used aspects can be predefined in a CDS aggregate and saved/delivered to be used by role developers. If no suitable aspect exists, the authorization developer can create a custom aspect(s) selecting another attribute of the ER model.

If a path from the aspect to a user exists, this path becomes part of the aspect definition so that it can be evaluated when a role is assigned to a user. The result is then used to propose user specific restriction values. Note that there might be aspects in the object model where no path from the aspect to user exists. (For example, from the resource entity product category). In this case no values will be proposed but the user administrator can assign the values per user manually. In some implementations, it is possible to add hierarchies to aspects, where a particular hierarchy defines whether instances in the organization structure of a company that are on a lower organization level can also be authorized when an instance from a higher level is assigned to a user. For example, if a manager is authorized, can a managed employee also be authorized by the manager's authorization (or vice versa).

In some implementations, example results for defining authorizations for the Sales Order 206 resource entity can include:

```
aspect aspSalesOrg as SELECT OrgID from SalesOrg where $user in
employee.usermame;
    //This aspect returns the grid point value: SalesOrg.OrgID retrieved
via the association path from
    // SalesOrg → Employee → Username (for the user to-be-
    assigned).
    aspect aspEmployeeCountry as SELECT countryCode from adress
where $user in adress.employee.username;
    //This aspect returns the grid point value: address.countryCode
retrieved via the association path from
    // Adress → Employee → Username (for the user to-be-assigned).
```

Note that the aspect “Product Category” resource entity 408 is represented by a set of values as there is no suitable path to the user for a value proposition:

aspect aspProductCategory as SELECT productCategory from product.

Next, the authorization developer defines a path from a resource entity to one or more aspects. The developer defines the path which is used to relate the aspect to the resource entity the authorization is restricted on. In the example of FIG. 4, the restriction on “Sales Order” resource entity 206 is possible on “Customer Country”, the “Sales Organization” of the “Sales Order,” and/or the “Product Category” of the products belonging to the sales order. In some implementations, example defined paths can resemble:

```
    DCL Path salesOrg; // the salesOrg is an attribute of the entity
resource Sales Order
    DCL Path customer.address[type=2 OR type=3].country; // a DCL
filter on the address type is used here
    DCL Path salesOrderItem[shipmentStatus =
open].product.productCategory; // a filter on the shipmentStatus is
introduced
```

In the example of the path to the product category, the selection of the Sales Order items depends on the additional DCL filter “shipmentStatus” 410. This allows taking into account only sales order lines that are in a certain shipment status. Another filter 412 is defined on the address type that is used to find the country of the customer. In the example, restrictions can also take into account calculated values. For example the overall value of a sales order can be considered and the value(s) calculated during execution time (e.g., on an aspect “total amount of order”). As will be appreciated by one of ordinary skill, any appropriate values, etc. can be defined, developed, etc.

Next, the authorization developer (acting as a role developer) defines restrictions for the aspects as part of the path definitions. The authorization developer links the above defined paths to the entities to the aspects and combines them with a quantifier. If no path between a user and aspect exists in the data model, there will not be any default values that a user is authorized for. In typical instances, an authorization developer oversees a specific application area and the role developer has an overview of the entire application and how authorizations for a particular entity are to be structured. Note that it is possible that a single individual can perform both tasks. In some implementations, example resultant constraint conditions for aspects defined above can be:

```
    Constraint Condition on Aspect aspSalesOrg {
    Order where salesOrg = aspect asp_SalesOrg // aspect exists
    }
    Constraint Condition on Aspect aspCustomerCountry {
    Order where customer.address[type=2 OR type=3],country = aspect
aspEmployeeCountry
    // aspect exists
    }
    Constraint Condition on Aspect aspProductCategory
    (shipmentstatus) {
    Order where salesOrderItem[shipmentStatus=
    open].product.productCategory = aspect
    aspProductCategory // no aspect path exists
    }
```

Note that in this last example, there is no path from the user to the product category in the data model. Therefore a set of possible values is used to define the user restriction.

Next, the authorization developer (acting as a role modeler) defines which constraint conditions (restrictions/rules) are used and how they are combined. In some implementations, the modeling steps to create a constraint condition are: 1) select one or more constraint conditions and combine them with Boolean operators and 2) decide which type of access is granted (“select”, “update”, etc.). In some implementations, the resulting syntax of the combination of all constraint conditions used for the rule can resemble:

```
    rule {
        grant select on SalesOrder {
```

| | |
|---|---|
| | where salesOrg = aspect asp_SalesOrg ; |
| and | where customer.address[type=2 OR type=3],country = |

aspect aspEmployeeCountry ;

| | |
|---|---|
| or | where salesOrderItem[shipmentStatus= |
| | open].product.productCategory = |

aspect aspProductCategory; }
}

Roles can then be defined as development objects by the role modeler using the above-defined rules. For example,

```
    Role SeniorSalesRep {
        grant select on SalesOrder {
```

| | |
|---|---|
| | where salesOrg = aspect asp_SalesOrg ; |
| and | where customer.address[type=2 OR type=3].country = |

aspect aspEmployeeCountry;

| | |
|---|---|
| or | where salesOrderItem[shipmentStatus= |

open].product.productCategory = aspect aspProductCategory; }
}

In this simple case the role “SeniorSalesRep” contains just one rule. In some implementations, a role can also contain other roles and several rules all combined with a logical “OR” as well as other appropriate values.

The user administrator will then decide per user instance restrictions. In some implementations, proposed instance values coming from an aspect definition can be overwritten. In some implementations, assignment of a role to a user can be performed by an application using a UI (e.g., a DML console on a client and an admintime application on an application server—see FIG. 8 for more detail).

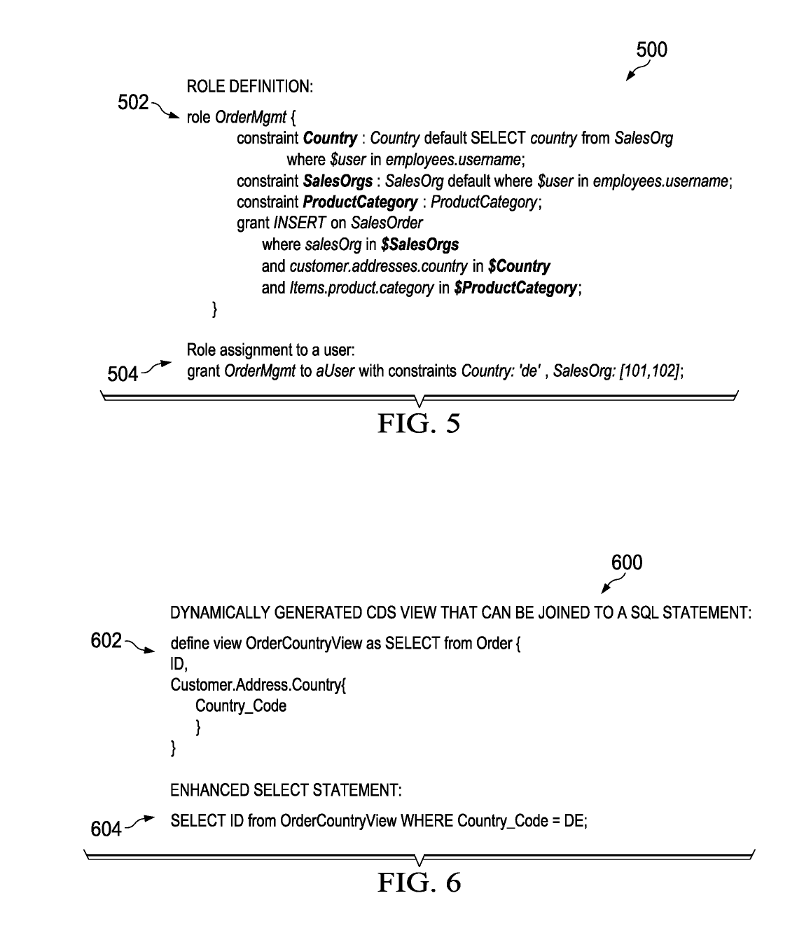

Turning to FIG. 5, FIG. 5 illustrates an example 500 of a role definition and assignment of the role definition to a user according to an implementation. The illustrated examples are presented in DCL syntax. The defined OrderMgmt role 502 is used in a grant assignment 504 to assign the OrderMgmt role 502 to a user “aUser” with constraints Country: ‘de,’ and SalesOrg: [101, 102].

Returning to FIG. 4, in some implementations, the developer of a role can decide whether a user administrator can modify the comparison operator between the aspect and the path to the entity. If the operator can be changed, it will be easier for the user administrator to select the value set for the aspects (ranges etc.) However there might be cases where the comparison operator is fixed. For example, the operator “=” makes sense to make sure that a restriction is always done with respect to a user. The following example of a role with user specific restrictions is in pseudo code.

```
    role SeniorSalesRep for user d000001 {
    grant select SalesOrder {
```

| | |
|---|---|
| | where salesOrg = ( 001, 002); |
| and | where customer.address[type=2 OR type=3].country = |
| | ( DE, FR );; |
| or | where salesOrderItem[shipmentStatus=open] |
| | .product.productCategory = |
| (ANY); } | |
| } | |

```
    grant insert, update, delete Order {// currently only select statements
    are supported
```

| | |
|---|---|
| | where salesOrg = (001, 002); |
| and | where salesOrderItem[shipmentStatus= |
| | open].product.productCategory = |
| (ANY); } | |
| } | |

In some implementations, the instance restrictions per user will only exist in the database and not in a separated document as CDS or DCL.

Runtime artifacts are generated by deploying DCL documents. Whenever a DCL document is deployed on a system, CDS “authorization views” are generated based on the DCL document information. Later, the generated authorization views are used during runtime to enhance, for example, a business application SQL SELECT statement. In other words, at runtime when a business application accesses a CDS entity, the SQL interface (e.g., SQL manager 809 in FIG. 8) will merge the authorization restrictions into the a WHERE clause of the SELECT statement (or into a FROM clause using and inner join—depending on the implementation). The system will check whether the user who is executing the statement has a matching role for this entity assigned. If the user has a matching role for the entity, the system will also read personal instance restrictions from the user role assignment and integrate them into the SQL statement.

In some implementations, only CDS entities with a modeled authorization modeled in a DCL document is checked. In some implementations, only the top level access to CDS entities will have an authorization check performed. If a CDS entity is wrapped, for example, by a non CDS view or a CDS view without a corresponding DCL model, then there will typically not be any authorization check. In some implementations, an example of a generated CDS authorization view which links a country code to a sales order could resemble that illustrated in FIG. 6.

FIG. 6 illustrates an example 600 of a generated CDS view and select statement enhanced by the addition of the CDS view according to an implementation. CDS view OrderCountryView 602 is used to enhance the SELECT statement 604 at runtime.

In another example, a business select statement could resemble:

```
    SELECT * FROM SalesOrders WHERE Supplier = ‘XYZ’;
    If the user is restricted to only see country code DE, the resulting
enhanced SQL could resemble:
    SELECT * FROM SalesOrders WHERE Supplier = ‘XYZ’
    AND EXISTS
        (SELECT * FROM OrderCountryView as av
            WHERE SalesOrders~id = av~id
            AND av~Country_Code = ‘DE’)
```

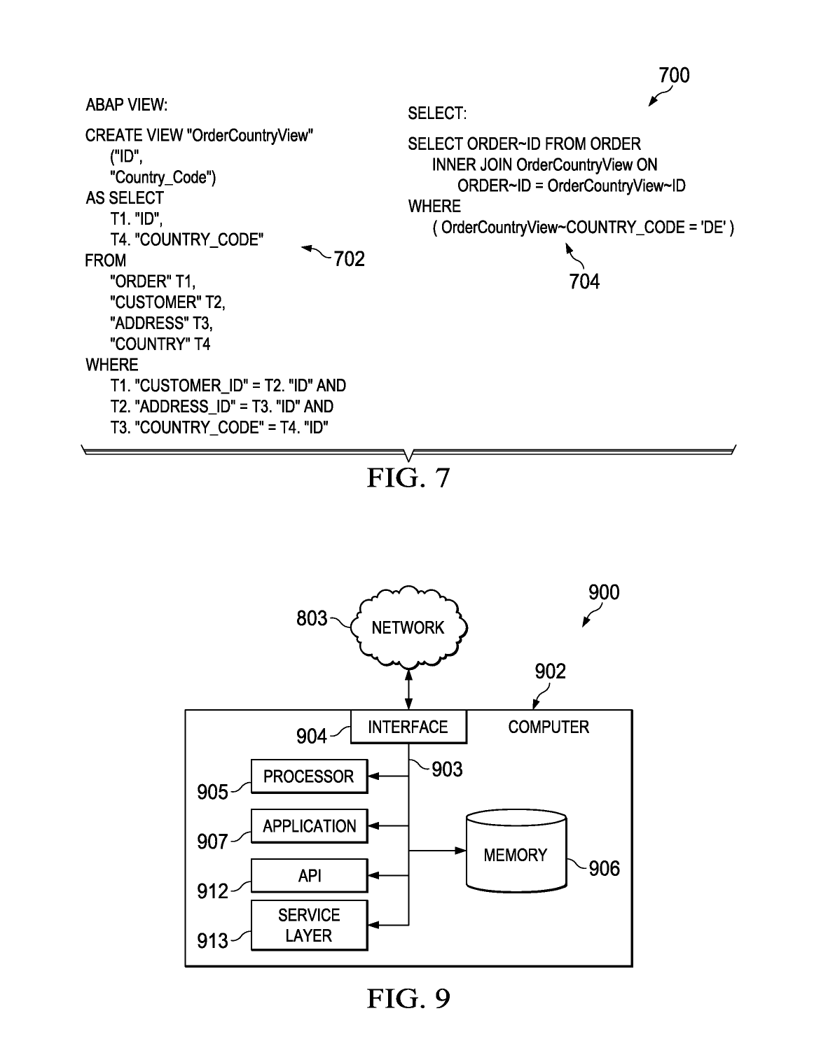

FIG. 7 illustrates example runtime generated views 700 according to an implementation. Here, ABAP view 702 can be created and then accessed at runtime in a SELECT or other SQL statement. The select statement 704, however, is dynamically enhanced with the dynamically generated “OrderCountryView” during runtime. As described above, the CDS “OrderCountryView” was previously dynamically generated based upon deployment of a DCL document with associated information causing the generation of the view. On issuing a SELECT statement (not illustrated), the system enhances the SELECT statement with the CDS view and transforms it into SELECT statement 704.

FIG. 8 is a high-level block diagram of an example distributed computing system (EDCS) 800 for providing declarative authorizations for SQL data manipulation according to an implementation. At a high-level, the EDCS 800 includes a client 802, application server 806, and a database server 810. Although illustrated with a single instance of each, in other implementations, the EDCS 100 can have a plurality of clients 802, application servers 806, and/or a database server 810. In some implementations, the client 802 can include mobile and/or non-mobile as well as virtual and/or physical devices, for example a desktop computer, a laptop computer, a tablet computer, a smartphone, a virtual machine, and the like. The application server 806 is used to execute applications, for example business application 808c, which access the database server 810 for data. In some implementations, the application server 806 can be a virtual and/or physical server. In some implementations, the database server 810 can be a virtual and/or physical server executing a conventional and/or an in-memory database.

The client 802 is used by a user for various purposes related to the EDCS 800. For example, a user with the client 802 can use an access a DCL source editor 804a to parse DCL source code and generate designtime artifacts (e.g., designtime data 812a) using a designtime application 808a executing on the application server 806. The DCL source editor 804a uses functionality in the application server 806 (e.g., code completion syntax checks, etc) and stores generated artifacts in the database server 810.

The user can also use a data manipulation language (DML) console 804b to access an admintime application 808b executing on the application server 806. The admintime application 806 allows the user to process DML commands to assign roles with restrictions to users and to generate runtime artifacts. The DML console 804b uses functionality of the application server 806 but stores all data (e.g., user specific data such as instance restrictions for single users. Note that this data is not part of a role model and therefore not included in the designtime data 812a) in the database server 810.

The user can also access a business-application UI 804c in order to access a business application 808c executing on the application server 806. In some implementations, the business application 808c executes SQL statements on the database server 810 in order to add, retrieve, modify, and/or delete database data (e.g., business data 812d). In some implementations, the business application 808c access the database server 810 through a SQL framework defining a common SQL syntax that can be executed in different SQL layers (e.g., databases) that internally use different SQL implementations or a database SQL processor (SQL manager) 809. In some implementations, the SQL manager 809 can execute wholly or partially on the application server 808 and/or the database server 810.

FIG. 9 is a block diagram 900 of an exemplary computer 902 used in the EDCS 800 according to an implementation. The illustrated computer 902 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 902 may comprise a computer that includes an input device, such as a keypad, keyboard, touch screen, or other device that can accept user information, and an output device that conveys information associated with the operation of the computer 902, including digital data, visual and/or audio information, or a UI.

The computer 902 can serve as a client, for example client 802, and/or a server, for example the application server 806 and/or the database server 810. The computer 902 can also serve as a computer for any other necessary component of the EDCS 800 (even if not illustrated) consistent with this disclosure. The illustrated computer 902 is communicably coupled with a network 903. In some implementations, one or more components of the computer 902 may be configured to operate within a cloud-computing-based environment.

At a high level, the computer 902 is an electronic computing device operable to receive, transmit, process, store, or manage data and information associated with the EDCS 800. According to some implementations, the computer 902 may also include or be communicably coupled with an application server, e-mail server, web server, caching server, streaming data server, business intelligence (BI) server, and/or other server.

The computer 902 can receive requests over network 903 from a client application (e.g., executing on another computer 902) and responding to the received requests by processing the said requests in an appropriate software application. In addition, requests may also be sent to the computer 902 from internal users (e.g., from a command console or by other appropriate access method), external or third-parties, other automated applications, as well as any other appropriate entities, individuals, systems, or computers.

Each of the components of the computer 902 can communicate using a system bus 903. In some implementations, any and/or all the components of the computer 902, both hardware and/or software, may interface with each other and/or the interface 904 over the system bus 903 using an application programming interface (API) 912 and/or a service layer 913. The API 912 may include specifications for routines, data structures, and object classes. The API 912 may be either computer-language independent or dependent and refer to a complete interface, a single function, or even a set of APIs. The service layer 913 provides software services to the computer 902 and/or the EDCS 800. The functionality of the computer 902 may be accessible for all service consumers using this service layer. Software services, such as those provided by the service layer 913, provide reusable, defined business functionalities through a defined interface. For example, the interface may be software written in JAVA, C++, or other suitable language providing data in extensible markup language (XML) format or other suitable format. While illustrated as an integrated component of the computer 902, alternative implementations may illustrate the API 912 and/or the service layer 913 as stand-alone components in relation to other components of the computer 902 and/or EDCS 800. Moreover, any or all parts of the API 912 and/or the service layer 913 may be implemented as child or sub-modules of another software module, enterprise application, or hardware module without departing from the scope of this disclosure.

The computer 902 includes an interface 904. Although illustrated as a single interface 904 in FIG. 9, two or more interfaces 904 may be used according to particular needs, desires, or particular implementations of the computer 902 and/or EDCS 800. The interface 904 is used by the computer 902 for communicating with other systems in a distributed environment—including within the EDCS 800—connected to the network 803 (whether illustrated or not). Generally, the interface 904 comprises logic encoded in software and/or hardware in a suitable combination and operable to communicate with the network 803. More specifically, the interface 904 may comprise software supporting one or more communication protocols associated with communications such that the network 803 or interface's hardware is operable to communicate physical signals within and outside of the illustrated EDCS 800.

The computer 902 includes a processor 905. Although illustrated as a single processor 905 in FIG. 9, two or more processors may be used according to particular needs, desires, or particular implementations of the computer 902 and/or the EDCS 800. Generally, the processor 905 executes instructions and manipulates data to perform the operations of the computer 902. Specifically, the processor 905 executes the functionality required to provide declarative authorizations for SQL data manipulation.

The computer 902 also includes a memory 906 that holds data for the computer 902 and/or other components of the EDCS 800. Although illustrated as a single memory 906 in FIG. 9, two or more memories may be used according to particular needs, desires, or particular implementations of the computer 902 and/or the EDCS 800. While memory 906 is illustrated as an integral component of the computer 902, in alternative implementations, memory 906 can be external to the computer 902 and/or the EDCS 800.

The application 907 is an algorithmic software engine providing functionality according to particular needs, desires, or particular implementations of the computer 902 and/or the EDCS 800, particularly with respect to functionality required to provide declarative authorizations for SQL data manipulation. For example, application 907 can serve as the DCL source editor 804a, DML console 804b, business-application UI 804c, designtime application 808a, admintime application 808b, business application 808x, SQL manager 809, and/or other application associated with the computer 902 and/or the EDCS 800 (whether illustrated or not). Further, although illustrated as a single application 907, the application 907 may be implemented as multiple applications 907 on the computer 902. In addition, although illustrated as integral to the computer 902, in alternative implementations, the application 907 can be external to the computer 902 and/or the EDCS 800.

There may be any number of computers 902 associated with, or external to, the EDCS 800 and communicating over network 803. Further, the term “client,” “user,” and other appropriate terminology may be used interchangeably as appropriate without departing from the scope of this disclosure. Moreover, this disclosure contemplates that many users may use one computer 902, or that one user may use multiple computers 902.

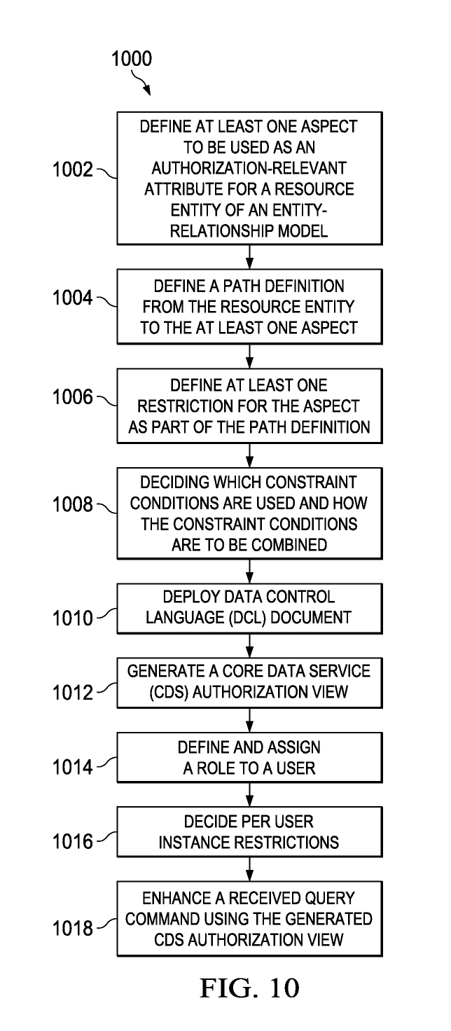

FIG. 10 is a flow chart illustrating a method 1000 for providing declarative authorizations for SQL data manipulation according to an implementation. For clarity of presentation, the description that follows generally describes method 1000 in the context of FIGS. 1A and 1B and FIGS. 2-9. However, it will be understood that method 1000 may be performed, for example, by any other suitable system, environment, software, and hardware, or a combination of systems, environments, software, and hardware as appropriate. In some implementations, various steps of method 1000 can be run in parallel, in combination, in loops, or in any order.

The flow chart illustrating the method 1000 represents three independent flows that depend upon each other: 1) development and deployment (design time flow) includes 1002-1008 (development) and 1010-1012 (deployment); 2) user administration by a user administrator includes 1014 and 1016 and are repetitive tasks performed once a system is set up; 3) runtime includes 1018 and occurs every time a query is executed against a protected resource.

Development

At 1002, at least one aspect is defined to be used as an authorization relevant attribute for a resource entity of an entity-relationship (ER) model. From 1002, method 1000 proceeds to 1004.

At 1004, a path definition if defined from the resource entity to the at least one aspect. From 1004, method 1000 proceeds to 1006.

At 1006, at least one restriction for the aspect is defined as part of the path definition. From 1006, method 1000 proceeds to 1008.

At 1008, which constraint conditions are to be used and how the constraint conditions are to be combined is decided. From 1008, method 1000 proceeds to 1010.

Deployment

At 1010, the DCL document is deployed. From 1010, method 1000 proceeds to 1012.

At 1012, a core data service authorization view is generated based on the deployed core data service authorization view. From 1012, method 1000 proceeds to 1014.

Repetitive Tasks

At 1014, a role to a user is defined and assigned. From 1014, method 1000 proceeds to 1016.

At 1016, per user instance restrictions are decided. From 1016, method 1000 proceeds to 1018.

Runtime

At 1018, a received query command is enhanced using the generated core data services authorization view. After 1018, method 1000 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a co-processor (e.g., a graphics/visual processing unit (GPU/VPU)), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of UI elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
defining, by a computer, a data access model, the definition comprising:
defining at least one aspect to be used as an authorization-relevant attribute for a resource entity of an entity-relationship model;
defining a path definition from the resource entity to the at least one aspect to relate the at least one aspect to the resource entity the authorization is restricted on;
defining at least one restriction for the at least one aspect as part of the path definition, wherein defining the at least one restriction includes determining which constraint condition are to be used and how the constraint conditions are to be combined; and
defining and assigning a role to a user, the role defining authorization to the resource entity using, at least in part, the at least one aspect; and
deploying a data control language (DCL) document defining the data access model.

2. The method of claim 1, further comprising making an existing path from the at least one aspect to a user a part of the at least one aspect so that it can be evaluated when a role is assigned to the user.

3. The method of claim 1, wherein the path definition can be defined by additional links that do not directly come from the entity-relationship model.

4. The method of claim 1, wherein defining the at least one restriction further comprises linking the defined path to the resource entity to the at least one aspect with a logical quantifier.

5. The method of claim 1, wherein defining a restriction further comprises:
selecting one or more restrictions and combining them with logical operators; and
deciding which type of access the defined restriction grants to the resource entity.

6. The method of claim 1, further comprising dynamically generating at least one core data service authorization view based on the deployed DCL document.

7. The method of claim 6, further comprising enhancing received query commands using the core data service authorization view.

8. A non-transitory, computer-readable medium storing computer-readable instructions executable by a computer and operable to:
define a data access model, the definition comprising:
defining at least one aspect to be used as an authorization-relevant attribute for a resource entity of an entity-relationship model;
defining a path definition from the resource entity to the at least one aspect to relate the at least one aspect to the resource entity the authorization is restricted on;
defining at least one restriction for the at least one aspect as part of the path definition, wherein defining the at least one restriction includes determining which constraint condition are to be used and how the constraint conditions are to be combined; and
defining and assigning a role to a user, the role defining authorization to the resource entity using, at least in part, the at least one aspect; and
deploy a data control language (DCL) document defining the data access model.

9. The medium of claim 8, further comprising instructions operable to make an existing path from the at least one aspect to a user a part of the at least one aspect so that it can be evaluated when a role is assigned to the user.

10. The medium of claim 8, wherein the path definition can be defined by additional links that do not directly come from the entity-relationship model.

11. The medium of claim 8, wherein defining the at least one restriction further comprises instructions operable to link the defined path to the resource entity to the at least one aspect with a logical quantifier.

12. The medium of claim 8, wherein defining a restriction further comprises instructions operable to:
select one or more restrictions and combining them with logical operators; and
decide which type of access the defined restriction grants to the resource entity.

13. The medium of claim 8, further comprising instructions operable to dynamically generate at least one core data service authorization view based on the deployed DCL document.

14. The medium of claim 13, further comprising instructions operable to enhance received query commands using the core data service authorization view.

15. A system, comprising:
at least one computer interoperably coupled with a memory storage and configured to:
define a data access model, the definition comprising:
defining at least one aspect to be used as an authorization-relevant attribute for a resource entity of an entity-relationship model;
defining a path definition from the resource entity to the at least one aspect to relate the at least one aspect to the resource entity the authorization is restricted on;
defining at least one restriction for the at least one aspect as part of the path definition, wherein defining the at least one restriction includes determining which constraint condition are to be used and how the constraint conditions are to be combined; and
defining and assigning a role to a user, the role defining authorization to the resource entity using, at least in part, the at least one aspect; and
deploy a data control language (DCL) document defining the data access model.

16. The system of claim 15, further configured to make an existing path from the at least one aspect to a user a part of the at least one aspect so that it can be evaluated when a role is assigned to the user.

17. The system of claim 15, wherein the path definition can be defined by additional links that do not directly come from the entity-relationship model.

18. The system of claim 15, wherein defining the at least one restriction further comprises linking the defined path to the resource entity to the at least one aspect with a logical quantifier.

19. The system of claim 15, wherein defining a restriction further comprises:
selecting one or more restrictions and combining them with logical operators; and
deciding which type of access the defined restriction grants to the resource entity.

20. The system of claim 15, further configured to:
dynamically generate at least one core data service authorization view based on the deployed DCL document; and
enhance received query commands using the core data service authorization view.
